(19) United States
(12) Patent Application Publication
(10) Pub. No.: US 2008/0106374 A1
(43) Pub. Date: May 8, 2008

(54) Patient Room Information System

(75) Inventor: David T. Sharbaugh, Pittsburgh, PA (US)

Correspondence Address: UPMC, FORBES TOWER, SUITE 10055-A, 200 LOTHROP ST., PITTSBURGH, PA, 15213-2582, US

(73) Assignee: UPMC, Pittsburgh, PA (US)

(21) Appl. No.: 11/926,226

(22) Filed: Oct. 29, 2007

Related U.S. Application Data
(60) Provisional application No. 60/863,978, filed on Nov. 2, 2006.

(51) Int. Cl. G05B 19/00

(52) U.S. Cl. 340/5.8; 705/2

(57) ABSTRACT

A point of care apparatus includes an identification system for automatically identifying the role of one or more persons in a room, a processor for determining information relevant to the role of the identified person, and a display for displaying the information. A method performed by the apparatus is also provided.

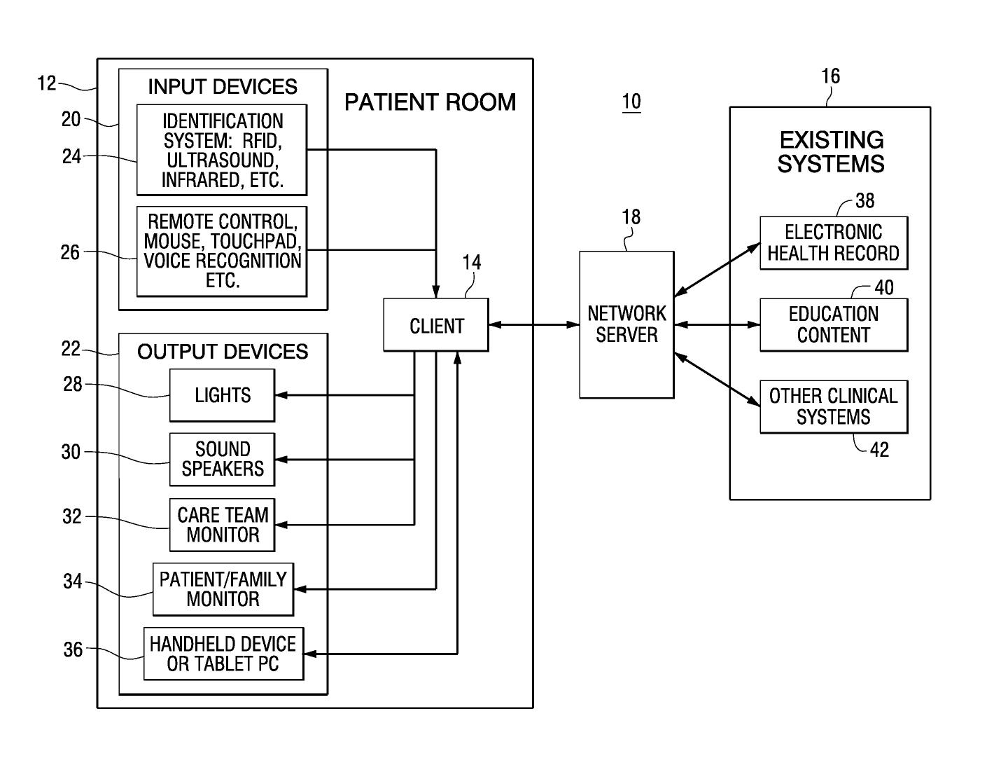

### CROSS-REFERENCE TO RELATED APPLICATION

This application claims the benefit of U.S. Provisional Patent Application Ser. No. 60/863,978, filed Nov. 2, 2006, the disclosure of which is hereby incorporated by reference.

### FIELD OF THE INVENTION

This invention relates to information systems configured for use at the point of care by care team members, patients, and others in a hospital or other health care facility, and to methods of using such information systems.

### BACKGROUND OF THE INVENTION

When providing patient care, it is important that the right person gets the right care, at the right time, every time. Imaging and other medical technology and clinical advancements have resulted in improvements in clinical treatments and interventions for patients. In addition, electronic health records (EHR), physician order entry, and clinical decision support, have all improved patient care. Positive Patient Identification (PPID) brings another level of technology advancement to decrease harmful medication events that happen as a result of mismatched information at the bedside.

There are many situations in health care where clinical and ancillary support teams do not always have the information that they need, where and when they need it. Historically, patient information is categorized by information type, including: labs, medications, orders, vital signs, etc. In addition, there is information about the patient that is present in electronic form but not always known to the caregivers and ancillary support personnel, such as housekeeping and dietary personnel. For example, information that the patient has dentures, or is being discharged today, is rarely known by the housekeeping or dietary aides, but is of value to those roles in helping to prevent errors, mistakes and rework.

Health care generally lacks real time systems to evaluate care patterns and schedules. As the dollars spent in health care continue to climb, with the majority of the dollars spent on the workforce, innovative ways to redesign care processes and work patterns are needed. By simplifying the work environment, waste will come out of the system, reducing the overall cost of care.

There is a need for a system that closely links information and the patient, and selectively supplies portions of the available patient information to members of a health care team, the patient, and others.

### SUMMARY OF THE INVENTION

In a first aspect the invention provides a point of care apparatus including an identification system for automatically identifying the role of one or more persons in a room, a processor for determining information relevant to the role of the identified person, and a display for displaying the information.

In a second aspect, the invention provides a method including: automatically identifying the role of one or more persons in a room, determining information relevant to the role of the identified person, and displaying the information.

### BRIEF DESCRIPTION OF THE DRAWINGS

The single FIGURE is a block diagram of a system constructed in accordance with an embodiment of the invention.

### DETAILED DESCRIPTION OF THE INVENTION

In a first aspect, the invention provides a system for pushing key clinical and other pertinent information such as reminders and alerts to persons that enter a patient's room based on that person's role and the situation. The system can also push information to the patient and family members that will assist in providing safe patient care and in improving the clinical experience through education and information sharing. In one embodiment, the system includes an identification system for automatically identifying persons or objects in the patient's room. The identification system may comprise, for example, an ultrasound system, an infrared system, or a Radio Frequency Identification (RFID) tag assigned to each member of the care team (doctors, nurses, respiratory therapists, phlebotomists, housekeepers, clergy, etc.). The identification system can identify patients, family members and certain types of major equipment.

In one example, an ultrasonic identification system includes a tag worn by the patient, family member and/or caregiver, or attached to equipment, which emits a series of sounds (which cannot be heard by humans) that are detected by a sensor located in the room. Each tag has a unique sound and a unique tag number. The detector sends the tag number to the processor which evaluates the owner of the tag and identifies relevant information based on decision logic. The tag may also include buttons which allow additional capabilities to control the information presented on the monitor.

In an operating scenario, when a member of the care team enters a patient's room; the identification system recognizes the person and their role and based on the decision logic implemented in a processor in the system, pushes information to a care team monitor in the patient's room. The care team monitor can be, for example, an electronic display that is mounted in the patient's room. A separate monitor, referred to as the patient/family monitor, can be included to display information of interest to the patient or the patient's family members. This monitor may display, for example, a list of the people in the room and their role, as well as other information designed to help the patient understand the clinical experience or to teach the patient about his or her clinical situation.

In one embodiment, the invention includes the combination of automatic identification technology (e.g., ultrasound, infrared, or RFID technology) and a communications link to the patient's electronic health record, and further includes the decision logic that determines just-in-time pertinent information, or controls other outputs such as sound or lights that are designed to help care team members and the ancillary support team do their work.

The decision logic will decide what information is needed in each situation and push that information in a just-in-time manner to one or more room output devices. Such output devices can include, for example, monitors, lights, speakers, and alarms. Once the person that activated the system leaves the room, the information will be removed from the output devices. This provides the care team and ancillary support team with a hands-free information and control system.

In one embodiment, the system is designed to include logic and decision rules that are implemented in software that resides on a network server. Information selected by the decision logic and/or control signals produced by the decision logic are delivered to a client or interface in the patient's room to manage and control the flow of inputs and outputs to various devices in the room.

The drawing is a block diagram of a system 10 constructed in accordance with an embodiment of the invention. The system includes various components that may be located in a patient's room 12. These components include a client 14 that communicates with other systems 16 through a network server 18. The network server includes software that can implement the decision logic used in operation of the system.

The in-room components include input devices 20 and output devices 22. The input devices include an identification system, such as an ultrasound identification system, an infrared identification system, or a RFID reader 24, and may include user interface devices 26 such as a touch pad, mouse, voice recognition or remote control. The output devices may include lights 28, speakers 30, a care team monitor 32, a patient/family monitor 34, and/or a handheld device or an RFID enabled tablet PC 36.

The network server can communicate with external information sources, such as an electronic health record 38, education content modules 40, and other clinical systems 42 over a communications link.

The identification system may utilize ultrasound, infrared, or RFID technology, to assess the situation in the room. In one example, the identification system will identify persons or objects in the room, for example by looking for a tag that can identify caregivers and support personnel and their role, a patient and his or her account information, visitors, and equipment. In this context, the equipment identification is used primarily for context purposes. In some embodiments, RFID tags or other identification devices can be used to invoke educational offerings for the patients. The input device 26 allows members of the care team to interact with the system.

Assessment of the situation in the room includes for example, the identification of the persons in the room, for example by their role in the care of the patient or operation of the facility, the locations of the persons in the room, the location of the patient, the presence and location of equipment, etc. If the system determines that a crash cart is in the room, then a set of protocols along with key clinical variables for the patient in arrest could be displayed.

The lights can be used to call attention to selected locations in the room for the patient and/or the care team. For example, a light near the sink or hand sanitizer may be automatically turned on to remind the care team of the need for hand washing and thereby assist in improving hand washing rates. The lights can be automatically triggered to turn on, and time off, based on the activity and context of the room situation.

Similar to the lights, sound speakers can be used to produce certain sounds, beeps, announcements, and/or music, based on the context of the situation. For example, the speakers may announce the people entering the room for the benefit of the patient, or may ask the patient to stay in bed until a caregiver comes to help them. The latter feature may prevent falls for high fall risk patients.

The care team monitor can be positioned for easy viewing by the care team and can display context specific information based on the caregiver or support personnel's role. For example, a dietary aide could be presented with the patient's diet order and the status of their dentures (Yes/No). If every clinical team that entered the room were presented with the patient's name, a picture and key demographic and clinical information, the likelihood of identification errors would be remote.

If information about a latex allergy were evident at the point of care, the likelihood of exposing the patient to latex gloves or other latex products and creating a serious allergic reaction would be very remote. If every housekeeper and dietary aide that came into a room to clean up was alerted that this patient had dentures, hearing aides and/or glasses (patient's belongings) and were taught to check before throwing anything away, the likelihood of throwing them away would be remote.

This information will help the dietary aide check for personal belongings while cleaning up to assure that the patient's personal belongings are not inadvertently discarded. In a more clinical application, the monitor can be used to push the last 24 hours of lab results, highlighting the critical lab values, and current medications due to the nurse when the nurse enters the room.

The patient/family monitor can provide instructions, alerts, and notices to the patient and family to help educate and involve them in the care. This monitor could also serve as the patient's TV and/or Internet access, but for this application, it is designed as a tool to push information content to the patient and the family.

A portable handheld device or tablet personal computer that is RFID enabled may be carried into the patient's room. Once the RFID system in the tablet PC picks up the patient's identification, the appropriate electronic health care information system may be retrieved on the tablet PC for use by the care team.

As used in this description, the client is a hardware product such as a personal computer (PC) or other processor that manages the inputs and outputs of the devices in the room. In one embodiment, the client is a stateless device. A stateless device is a hardware component with no hard drive, fans or other “moving parts”. The use of a stateless device can reduce heat generation and noise in the room.

The network server can house the programming logic that both assesses the inputs for the situation in the room, as well as decides what information to push to the room monitors, where and how to get that information, and when and how to push it to the appropriate output device. A communications link, which can be wired or wireless, can be established between the server and the client.

The network server function can be independent of the tablet PC that can be linked to other systems using wireless technology.

The other systems 16 can be previously existing systems that are external to the components of the invention. These are systems that house clinical and non-clinical information from which the invention will pull the content needed to provide the desired in-room functions. Each hospital has different systems, and the components of this invention can be designed to work with any system through interfaces built to fetch the appropriate piece of information from the existing systems.

In one aspect, this invention provides a system where information is delivered to the people that need it, where it is needed, when it is needed. For example, when a nurse walks into the room, key clinical information about the patient, the recently administered and upcoming medications, a picture of the patient, and a list of allergies, can be displayed on the care team monitor behind the patient. The moment that the nurse leaves the room, the information disappears from the care team monitor. When a dietary aide walks into the room, information about the patient's dietary restrictions and needs appears on the care team monitor. When the caregivers get within a certain distance (e.g., 4 feet) of the patient's bed, the care team monitor can display a hand washing symbol to remind the caregivers to wash their hands.

The location of the caregiver, support personnel, patient and/or family members can be determined using known techniques for processing identification signals. For example, one or more identification signal readers could be positioned in the room to allow the system to sense the presence of a tag in the space and/or allow triangulation through multiple sensors to assess a more specific location of a tag in the room. For example, the system could determine when a patient gets out of the bed.

In another aspect, this invention combines identification technology with the electronic health record (EHR) and uses logical rules between them so that each caregiver and non-caregiver has a set of information that matters when they enter the room. In addition, the patient sees specified information and can be more involved in his or her care.

The system can be programmed to provide various features that improve patient care. For example, the system can announce caregivers and support staff as they enter the room, so the patient and family members know the role of that person. When the caregiver gets within a certain distance of the patient's bed, the care team monitor can flash a symbol for hand hygiene reminding the caregiver to use the hand sanitizer.

When a caregiver enters the room, patient allergy information can be displayed in the form of an allergy alert through the display and/or a voice alert. When a patient gets out of bed, and it is nighttime, the bathroom light can be automatically turned on.

When a nurse enters the room, a schedule for the patient can appear on the care team monitor, showing what needs to be done for that patient at that time. This would allow nurses to move from room to room and get their “next steps” from the system based on the needs of the patients at that specific time. When a nursing assistant enters the room, the patient's schedule for vitals, I/O charting, bath, etc. may appear on the care team monitor, similar to the nursing schedule.

A picture of the patient can appear on the care team monitor as an additional form of identification.

When a physician arrives, the care team monitor can show critical lab values along with recent medications, so that the physician can assess the clinical relationships between these parameters.

The family members can be given updated communication as part of their “walking into” the patient's room—what's been done, how well they slept, what new orders have transpired, etc.

A schedule for the day can be presented on the patient/family monitor. For patients with personal belongings, the belongings can be placed in a case having an identification tag. The tag reader will monitor the room for the presence of the case. If the case is taken out of the room, a signal is sent to the person taking the case, indicating that the case has been separated from the patient. As long as the patient uses the case, it will prevent loss of personal belongings.

The key clinical process measures for identified patients (for example, heart failure, pneumonia, acute myocardial infarction, etc.) can be presented as a series of check marks either completed or open to assure that those patients meet the clinical guidelines and requirements of the Joint Commission on Accreditation of Healthcare Organizations (JCAHO) and the Center for Medicare and Medicaid Services (CMMS). The logic and rules can also be presented for understanding the importance of publicly reported measures for JCAHO, as well as other evidence based clinical protocols.

Medication information can be presented to pharmacists for medication rounds. A pharmacist can travel room to room and quickly identify opportunities and risks associated with medication administration. This can enhance the ability of the pharmacist to be more involved in the clinical care of the patients.

At discharge, when the nurse is teaching the patient, the medications and associated teaching materials can be displayed on the patient/family monitor to improve the effectiveness of medication reconciliation as well as teaching. In addition, the medications that the patient came with prior to admittance to the hospital can be presented to facilitate teaching and reconciliation.

If the patient has a high risk of falling, the patient/family monitor can remind the patient of the risk of falling. If the patient tries to get out of bed without someone else in the room, the speaker can prompt the patient with an announcement such as: “I have notified the care team, please wait while they assist you out of bed”.

If a central line kit, which is used to insert a major access line, has an identification tag and is brought into the room, a set of key instructions and techniques can be presented on the care team monitor so that the care team is “assisted” as needed to help prevent central line infections.

If the patient is on a ventilator, the care team monitor can show the protocol/bundle for ventilator patients to help prevent ventilator-assisted pneumonia.

Things like hydration, visual stimulation and verbal discussion can have a major impact on the geriatric outcomes relative to delirium. The patient/family monitor can include information that the family members can access for their involvement in the patient's care.

The physician can call up electronic health record pictures and show the patients their images and results of tests. Through voice recognition or the remote input device, the physician could call up the imaging studies for display on either panel.

In addition to the above clinical operations, the system can capture other information that can be used to adjust and evaluate care, for example: the amount of time a nurse or doctor spends with patients, the frequency of patient contact, the relationship between satisfaction scores and time with patients, and/or the time the patient is off the floor for tests, etc. This information can be used for root cause analysis in the event that problems occur, and for tracking of problems and corrective measures.

In addition to the benefits described above, this invention can change the way care is delivered to patients. If complete information in the EHR is immediately available in the patient's room, then the care team can become much more focused on the value they bring to the patients in terms of care, knowledge, and service, rather than worrying about “what do I do next”. With readily available schedule information, caregivers and support personnel can have a better opportunity to evaluate whether or not, and by how much, they are ahead or behind in their work.

In addition, the family can become more involved in their family member's care in ways that have not been explored fully in the traditional model of care delivery.

The invention can be extended to applications in the Emergency Department, Operating Room, and other clinical areas not described above. Such other areas should receive the same kinds of benefits in cost, quality, safety and service as well.

The decision logic can assess the presence of a specific person or equipment in the room. That person or equipment will have an assigned role (e.g., housekeeper, pastor, nurse, IV nurse, dietary aide, etc.) and that role will have a set of output activities associated with it. Those activities can be designed into the logic of the system (e.g., turn on a light, make a sound, push a voice message to a speaker, serve up clinical and non-clinical information to one of the monitors in the room). The system can also have rules to govern the combination of roles present at any one point in time. For example, if the housekeeper is in the room and the nurse shows up, the system will recognize both and make a decision about the presentation of information but may include options such as, splitting the screen or sharing the screen by fading back and forth between or developing a combination screen for common care team combinations like the doctor and the nurse.

In one aspect of the invention, the point of care system can provide relevant information to both caregivers and non-caregivers. The information can be provided automatically, without requiring any action on the part of the person to request the information. That is, the information is “pushed” to the display or other output device. The system automatically identifies one or more persons in the room, and the role of the identified person(s) with respect to the patient. The server or processor is programmed to select information that is relevant to the role of the identified person. Then the selected information is transmitted to the room.

In another aspect, the system can include control, monitoring, or notification functions. The identification system may be configured to determine the location of an identified person. Then the server or processor can use that location information to provide an appropriate response. For example, if a patient gets out of bed, the system can turn on a light, issue an audible warning, reminder, or alert.

With respect to the privacy of information, this system can be designed to provide maximum privacy through the use of symbols, color and sound that is known specifically to the intended role where possible. In addition, the display of sensitive information can be controlled by using the input device (e.g., tag buttons, remote control and/or voice recognition) to protect patient information and privacy. For example, when a caregiver initially enters a patient's room, the system may display a first set of information, such as patient allergies. Then the caregiver might ask the patient for permission to see additional information that might exist in the patient's electronic medical record, such as test results. Upon receiving such permission, the caregiver may use the input device to signal a request for the additional information, which would then be displayed. In addition, the input device might be used to switch among various possible display formats or among several possible screen displays. The system may also include an on/off feature for sensitive information and will protect patient privacy through monitor positioning in the room.

While the invention has been described in terms of several embodiments, it will be apparent to those skilled in the art that various changes can be made to the described embodiments without departing from the scope of the invention as set forth in the claims.

What is claimed is:

1. A point of care apparatus comprising:
an identification system for automatically identifying the role of one or more persons in a room;
a processor for determining information relevant to the role of the identified person; and
a display for displaying the information.

2. The apparatus of claim 1, wherein the processor further controls one or more output devices.

3. The apparatus of claim 1, wherein the information relevant to the role of the identified person is only displayed while that identified person is in the room.

4. The apparatus of claim 1, wherein the processor includes software implemented decision rules.

5. The apparatus of claim 1, wherein the identification system senses information on tags on the persons and/or on objects.

6. The apparatus of claim 1, further comprising an input device for controlling the display and/or recording events in the room.

7. The apparatus of claim 1, wherein the relevant information relates to equipment in the room.

8. The apparatus of claim 1, further comprising:
a client for managing inputs and outputs of devices in the room; and
a communications link between the client and the processor.

9. The apparatus of claim 8, wherein the client is a stateless device.

10. The apparatus of claim 1, wherein the identification system comprises an ultrasound identification system.

11. The apparatus of claim 1, wherein the processor accesses an electronic health record.

12. The apparatus of claim 1, wherein the information includes a checklist of clinical guidelines.

13. The apparatus of claim 1, wherein the relevant information is determined using the role of the identified person in combination with other information relevant to a patient.

14. The apparatus of claim 1, wherein the identification system further determines a location of the identified person, and the processor produces an output signal in response to the location.

15. A method comprising:
automatically identifying the role of one or more persons in a room;
determining information relevant to the role of the identified person; and
displaying the information.

16. The method of claim 15, wherein the information relevant to the role of the identified person is only displayed while that identified person is in the room.

17. The method of claim 15, wherein the step of automatically identifying the role of one or more persons in a room senses information on tags on the identified persons.

18. The method of claim 15, wherein the step of automatically identifying the role of one or more persons in a room is implemented using an ultrasound identification system.

19. The method of claim 15, wherein the information includes a checklist of clinical guidelines.

20. The method of claim 15, further comprising:
determining a location of the identified person; and
producing an output signal in response to the location.
